(19) United States
(12) Patent Application Publication
(10) Pub. No.: US 2012/0001116 A1
(43) Pub. Date: Jan. 5, 2012

(54) MAGNETIC MULTILAYER PIGMENT FLAKE AND COATING COMPOSITION

(75) Inventors: Vladimir P. Raksha, Santa Rosa, CA (US); Paul T. Kohlmann, Windsor, CA (US); Cornelis Jan Delst, Fairfax, CA (US); Paul G. Coombs, Santa Rosa, CA (US)

(73) Assignee: JDS Uniphase Corporation, Milpitas, CA (US)

(21) Appl. No.: 12/828,069

(22) Filed: Jun. 30, 2010

(51) Int. Cl. H01F 1/047; C09D 11/02

(52) U.S. Cl. 252/62.55

(57) ABSTRACT

The present invention provides a magnetic multilayer pigment flake and a magnetic coating composition that are relatively safe for human health and the environment. The pigment flake includes one or more magnetic layers of a magnetic alloy having a substantially nickel-free composition including about 40 wt % to about 90 wt % iron, about 10 wt % to about 50 wt % chromium, and about 0 wt % to about 30 wt % aluminum. The coating composition includes a plurality of the pigment flakes disposed in a binder medium.

### TECHNICAL FIELD OF THE INVENTION

The present invention relates to multilayer pigment flakes and to coating compositions incorporating such pigment flakes. In particular, the present invention relates to magnetic multilayer pigment flakes and to magnetic coating compositions.

### BACKGROUND OF THE INVENTION

Chromium-containing materials are widely used in coating compositions because of their advantageous optical-absorption and corrosion-inhibiting properties. In many coating compositions, such as interference coating compositions, layers of chromium-containing materials are used as absorbing layers in multilayer pigment flakes.

For example, as disclosed in U.S. Pat. No. 3,858,977 to Baird, et al., issued on Jan. 7, 1975, in U.S. Pat. No. 5,059,245 to Phillips, et al., issued on Oct. 22, 1991, in U.S. Pat. No. 5,571,624 to Phillips, et al., issued on Nov. 5, 1996, in U.S. Pat. No. 6,132,504 to Kuntz, et al., issued on Oct. 17, 2000, and in U.S. Pat. No. 6,156,115 to Pfaff, et al., issued on Dec. 5, 2000, which are incorporated herein by reference, layers of chromium metal may be used as absorbing layers. As disclosed in U.S. Pat. No. 4,978,394 to Ostertag, et al., issued on Dec. 18, 1990, and in U.S. Pat. No. 5,364,467 to Schmid, et al., issued on Nov. 15, 1994, which are incorporated herein by reference, layers of chromium(III) oxide (Cr₂O₃) may be used as absorbing layers. As disclosed in U.S. Pat. No. 5,424,119 to Phillips, et al., issued on Jun. 13, 1995, in U.S. Pat. No. 6,235,105 to Hubbard, et al., issued on May 22, 2001, in U.S. Pat. No. 6,524,381 to Phillips, et al., issued on Feb. 25, 2003, in U.S. Pat. No. 6,648,957 to Andes, et al., issued on Nov. 18, 2003, in U.S. Pat. No. 6,759,097 to Phillips, et al., issued on Jul. 6, 2004, in U.S. Pat. No. 6,818,299 to Phillips, et al., issued on Nov. 16, 2004, and in U.S. Pat. No. 7,169,472 to Raksha, et al., issued on Jan. 30, 2007, which are incorporated herein by reference, layers of chromium-containing alloys, such as Hastelloys, Inconels, stainless steels, and nickel-chromium alloys, may be used as absorbing layers.

Unfortunately, many of the chromium-containing materials in the absorbing layers of prior-art coating compositions are harmful to human health. Chromium metal and chromium(III) oxide, for example, each cause irritation to the skin, eyes, respiratory tract, and gastrointestinal tract. Moreover, these materials may be oxidized to form chromium(VI) species, which are, generally, toxic and carcinogenic. Furthermore, the chromium-containing alloys used in the absorbing layers of prior-art coating compositions, typically, also contain nickel, which is toxic and carcinogenic. Therefore, many prior-art coating compositions based on chromium-containing materials pose potential health and environmental hazards.

### SUMMARY OF THE INVENTION

An object of the present invention is to overcome the shortcomings of the prior art by providing a magnetic multilayer pigment flake and a magnetic coating composition that are relatively safe for human health and the environment.

Accordingly, the present invention relates to a magnetic multilayer pigment flake comprising a magnetic layer of a magnetic alloy having a substantially nickel-free composition including about 40 wt % to about 90 wt % iron, about 10 wt % to about 50 wt % chromium, and about 0 wt % to about 30 wt % aluminum.

Another aspect of the present invention relates to a magnetic coating composition comprising: a binder medium; and a plurality of magnetic multilayer pigment flakes disposed in the binder medium, wherein the plurality of pigment flakes each comprise a magnetic layer of a magnetic alloy having a substantially nickel-free composition including about 40 wt % to about 90 wt % iron, about 10 wt % to about 50 wt % chromium, and about 0 wt % to about 30 wt % aluminum.

Preferably, the composition of the magnetic alloy is selected to minimize chromium(VI) release.

### BRIEF DESCRIPTION OF THE DRAWINGS

The present invention will be described in greater detail with reference to the accompanying drawings, which represent exemplary embodiments thereof, wherein:

FIG. 1A is a schematic illustration of a cross-section of a first preferred embodiment of a magnetic multilayer pigment flake;

FIG. 1B is a plot of the angle-dependent color travel of a magnetic coating composition comprising a plurality of the pigment flakes of FIG. 1A having the following layer structure: Fe—Cr, semi-transparent/MgF₂, 370 nm/Al, opaque/MgF₂, 370 nm/Fe—Cr, semi-transparent;

FIG. 1C is a plot of the angle-dependent color travel of a magnetic coating composition comprising a plurality of the pigment flakes of FIG. 1A having the following layer structure: Fe—Cr—Al, semi-transparent/MgF₂, 370 nm/Fe—Cr—Al, opaque/MgF₂, 370 nm/Fe—Cr—Al, semi-transparent;

FIG. 2A is a schematic illustration of a cross-section of a second preferred embodiment of a magnetic multilayer pigment flake having a first layer-thickness profile;

FIG. 2B is a schematic illustration of a cross-section of a second preferred embodiment of a magnetic multilayer pigment flake having a second layer-thickness profile;

FIG. 3A is a schematic illustration of a preferred embodiment of a coating composition being exposed to microwave radiation; and

FIG. 3B is a schematic illustration of the coating composition illustrated in FIG. 3A being exposed to a magnetic field.

### DETAILED DESCRIPTION OF THE INVENTION

The present invention provides a magnetic multilayer pigment flake and a magnetic coating composition incorporating such pigment flakes. The pigment flake and, consequently, the coating composition substantially preclude the release of potentially harmful nickel and chromium(VI), while providing advantageous magnetic, optical, and corrosion-inhibiting properties.

The pigment flake includes a plurality of thin-film layers of various materials. Generally, the pigment flake has an aspect ratio of at least 2:1 and an average particle size of about 2 μm to about 20 μm.

In particular, the pigment flake includes one or more magnetic layers of a magnetic alloy, i.e. a ferro- or ferrimagnetic alloy, enabling the pigment flake to be aligned with a magnetic field. The magnetic alloy has a nickel-free composition including iron and chromium. Optionally, the composition of the magnetic alloy may also include other metals, such as aluminum, minor constituents, and/or impurities.

In the magnetic alloy, the chromium atoms are bonded by metallic bonds, which involve the sharing of electrons. Thus, chromium is present in the magnetic alloy as chromium(0). If the magnetic alloy is subject to corrosion, chromium is mainly released as chromium(III), rather than potentially harmful chromium(VI). Moreover, a chromium(III)-containing oxide may be formed, which passivates the surface of the magnetic alloy, inhibiting further corrosion.

The inventors have found that a composition of the magnetic alloy including about 40 wt % to about 90 wt % iron, about 10 wt % to about 50 wt % chromium, and about 0 wt % to about 30 wt % aluminum minimizes the undesirable release of chromium(VI), but retains desirable magnetic, optical, and corrosion-inhibiting properties. Preferably, the pigment flake releases substantially no chromium(VI).

In a preferred embodiment, which provides advantageous optical-absorption properties, the magnetic alloy is an iron-chromium alloy having a composition consisting of about 10 wt % to about 50 wt % chromium and a balance of iron. In another preferred embodiment, which provides advantageous optical-reflection properties, the magnetic alloy is an iron-chromium-aluminum alloy having a composition consisting of about 20 wt % to about 30 wt % chromium, about 20 wt % to about 30 wt % aluminum, and a balance of iron.

The pigment flake, typically, includes a plurality of magnetic layers of the magnetic alloy, in addition to a plurality of dielectric layers. Optionally, the pigment flake may also include layers of other types.

The magnetic layers of the magnetic alloy, typically, serve as absorbing layers for absorbing light and/or as reflecting layers for reflecting light. The magnetic layers may be formed of the same or different magnetic alloys and may have the same or different physical thicknesses. Generally, the magnetic layers each have a physical thickness of about 3 nm to about 1000 nm. In instances where the magnetic layers serve as absorbing layers, the magnetic layers are semi-transparent, each, typically, having a physical thickness of about 3 nm to about 50 nm. Preferably, such semi-transparent absorbing magnetic layers each have a physical thickness of about 5 nm to about 15 nm. In instances where the magnetic layers serve as reflecting layers, the magnetic layers are opaque, each, typically, having a physical thickness of about 20 nm to about 1000 nm. Preferably, such opaque reflecting magnetic layers each have a physical thickness of about 50 nm to about 100 nm.

In some instances, an opaque layer of a reflective material other than the magnetic alloy may serve as a reflecting layer for reflecting light. Suitable reflective materials include tin, aluminum, copper, silver, gold, palladium, platinum, titanium, and compounds or alloys thereof. Such an opaque reflecting layer is, preferably, formed of aluminum. Typically, such an opaque reflecting layer has a physical thickness within the same ranges as the opaque reflecting magnetic layers.

The dielectric layers, typically, serve as transparent spacer layers, and provide the pigment flake with durability and rigidity. The dielectric layers may be formed of any transparent dielectric material having a low refractive index, i.e. a refractive index of less than about 1.65, or a high refractive index, i.e. a refractive index of greater than about 1.65. Suitable dielectric materials having a low refractive index include silicon dioxide (SiO₂), aluminum oxide (Al₂O₃), and metal fluorides, such as magnesium fluoride (MgF₂). Suitable dielectric materials having a high refractive index include silicon monoxide (SiO) and zinc sulfide (ZnS). Preferably, the dielectric layers are formed of magnesium fluoride.

The dielectric layers may be formed of the same or different dielectric materials and may have the same or different physical thicknesses. Generally, the dielectric layers each have a physical thickness of about 100 nm to about 5000 nm. The physical thickness is selected to correspond with an optical thickness required by a layer structure of the pigment flake for providing a desired optical effect.

The pigment flake may have a variety of layer structures, having various compositional and layer-thickness profiles, for providing a variety of optical effects. Preferably, the pigment flake has an interference layer structure for providing a color-shifting effect through the interference of light, such that the pigment flake changes color with viewing angle or angle of incident light.

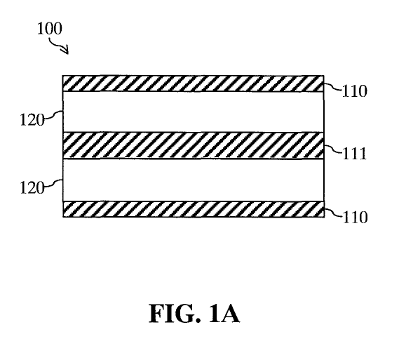

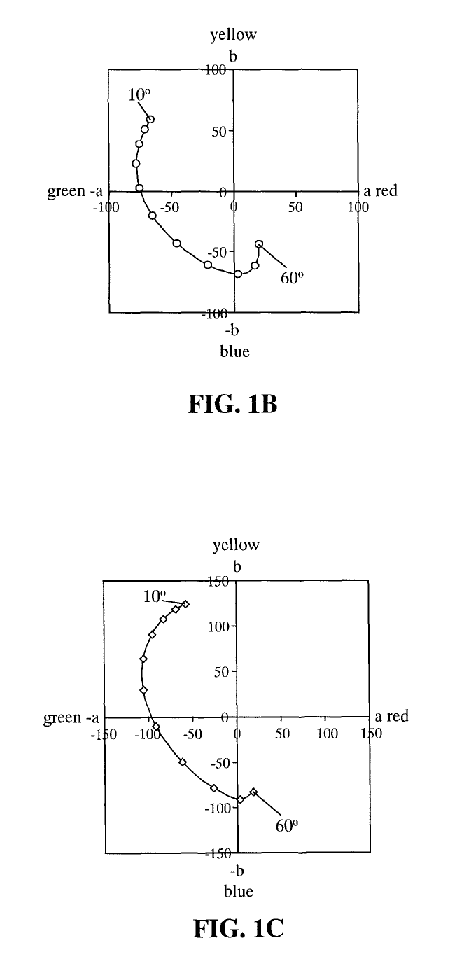

With reference to FIG. 1A, a first preferred embodiment of the pigment flake 100 has a symmetrical interference layer structure including five layers: two semi-transparent absorbing magnetic layers 110, two transparent dielectric layers 120, and one opaque reflecting layer 111, which may be non-magnetic or magnetic. A first transparent dielectric layer 120 overlies a first semi-transparent absorbing magnetic layer 110, a central opaque reflecting layer 111 overlies the first transparent dielectric layer 120, a second transparent dielectric layer 120 overlies the central opaque reflecting layer 111, and a second semi-transparent absorbing magnetic layer 110 overlies the second transparent dielectric layer 120.

The first and second semi-transparent absorbing magnetic layers 110 are formed of the magnetic alloy, and the first and second transparent dielectric layers 120 are formed of a dielectric material, as described heretofore.

In some embodiments, the central opaque reflecting layer 111 is formed of a reflective material other than the magnetic alloy, as described heretofore. To illustrate such an embodiment, a layer stack was fabricated having the following layer structure: Fe—Cr, semi-transparent/MgF₂, 370 nm/Al, opaque/MgF₂, 370 nm/Fe—Cr, semi-transparent. First and second semi-transparent absorbing magnetic layers 110 of an iron-chromium alloy, first and second transparent dielectric layers 120 of magnesium fluoride, and a central opaque reflecting layer 111 of aluminum were deposited by evaporation in vacuum onto a polyester substrate. The iron-chromium alloy had a composition consisting of about 14 wt % chromium and a balance of iron.

The layer stack was stripped from the substrate and ground to form a plurality of pigment flakes 100 having an average particle size of about 20 μm. The plurality of pigment flakes 100 were combined with a binder medium to form a coating composition, and the coating composition was printed onto a paper substrate and dried. The color-shifting properties of the printed coating composition were then analyzed with a goniospectrophotometer. The angle-dependent color travel of the printed coating composition with a change of viewing angle from 10° to 60° is plotted in FIG. 1B.

In other embodiments, the central opaque reflecting layer 111 is formed of the magnetic alloy, preferably, embodied as an iron-chromium-aluminum alloy, such that the magnetic layers 110 and 111 alternate with the dielectric layers 120. To illustrate such an embodiment, a layer stack was fabricated having the following layer structure: Fe—Cr—Al, semi-transparent/MgF₂, 370 nm/Fe—Cr—Al, opaque/MgF₂, 370 nm/Fe—Cr—Al, semi-transparent. First and second semi-transparent absorbing magnetic layers 110 of an iron-chromium-aluminum alloy, first and second transparent dielectric layers 120 of magnesium fluoride, and a central opaque reflecting magnetic layer 111 of the iron-chromium-aluminum alloy were deposited by evaporation in vacuum onto a polyester substrate to form the layer stack. The iron-chromium-aluminum alloy had a composition consisting of about 24 wt % chromium, about 27 wt % aluminum, and a balance of iron.

The layer stack was stripped from the substrate and ground to form a plurality of pigment flakes 100 having an average particle size of about 20 μm. The plurality of pigment flakes 100 were combined with a binder medium to form a coating composition, and the coating composition was printed onto a paper substrate and dried. The color-shifting properties of the printed coating composition were then analyzed with a goniospectrophotometer. The angle-dependent color travel of the printed coating composition with a change of viewing angle from 10° to 60° is plotted in FIG. 1C.

Advantageously, embodiments of the pigment flake that include a plurality of magnetic layers of the magnetic alloy in alternation with a plurality of dielectric layers absorb microwave radiation particularly well, allowing the pigment flake to be heated with microwave radiation. In such embodiments, the magnetic alloy serves three different functions: enabling microwave absorption by the pigment flake, enabling optical absorption by the pigment flake, and enabling magnetic alignment of the pigment flake.

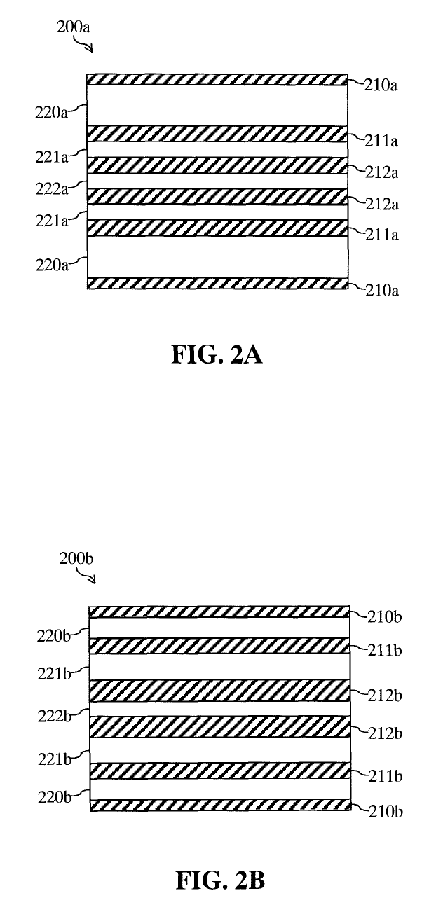

With reference to FIGS. 2A and 2B, a second preferred embodiment of the pigment flake 200 has a symmetrical interference structure including eleven layers: two semi-transparent absorbing magnetic layers 210, five transparent dielectric layers 220, 221, and 222, and four opaque reflecting magnetic layers 211 and 212. A first transparent dielectric layer 220 overlies a first semi-transparent magnetic layer 210, a first opaque reflecting magnetic layer 211 overlies the first transparent dielectric layer 220, a second transparent dielectric layer 221 overlies the first opaque reflecting magnetic layer 211, a second opaque reflecting magnetic layer 212 overlies the second transparent dielectric layer 221, a third transparent dielectric layer 222 overlies the second opaque reflecting magnetic layer 212, a third opaque reflecting magnetic layer 212 overlies the third transparent dielectric layer 222, a fourth transparent dielectric layer 221 overlies the third opaque reflecting magnetic layer 212, a fourth opaque reflecting magnetic layer 211 overlies the fourth transparent dielectric layer 221, a fifth transparent dielectric layer 220 overlies the fourth opaque reflecting magnetic layer 211, and a second semi-transparent absorbing magnetic layer 210 overlies the fifth transparent dielectric layer 220, such that the magnetic layers 210, 211, and 212 alternate with the dielectric layers 220, 221, and 222.

The first and second semi-transparent absorbing magnetic layers 210, and the first, second, third, and fourth opaque reflecting magnetic layers 211 and 212 are formed of the magnetic alloy. The first, second, third, fourth, and fifth transparent dielectric layers 220, 221, and 222 are formed of a dielectric material, as described heretofore.

The pigment flake 200 may have various layer-thickness profiles selected to optimize resonant microwave absorption over a large bandwidth. With particular reference to FIG. 2A, according to a first layer-thickness profile of the pigment flake 200a, the first, second, third, and fourth opaque reflecting magnetic layers 211a and 212a have the same physical thickness, which is larger than that of the first and second semi-transparent absorbing magnetic layers 210a. The second, third, and fourth transparent dielectric layers 221a and 222a have the same physical thickness, which is smaller than that of the first and second transparent dielectric layers 220a.

With particular reference to FIG. 2B, according to a second layer-thickness profile of the pigment flake 200b, the physical thickness of the second and third opaque reflecting magnetic layers 212b is larger than that of the first and fourth opaque reflecting magnetic layers 211b, which is larger than that of the first and second semi-transparent absorbing magnetic layers 210b. The physical thickness of the third transparent dielectric layer 222b is smaller than that of the first and fourth transparent dielectric layers 220b, which is smaller than that of the second and third transparent dielectric layers 221b. Advantageously, such a layer-thickness profile provides a particularly large bandwidth of microwave absorption.

Of course, numerous other embodiments of the pigment flake provided by the present invention may be envisaged without departing from the spirit and scope of the invention.

The pigment flake of the present invention can be formed by various fabrication methods, as disclosed in U.S. Pat. No. 5,059,245, in U.S. Pat. No. 5,571,624, in U.S. Pat. No. 6,524,381, and in U.S. Pat. No. 6,818,299, for example. Generally, some or all of the component layers are sequentially deposited on a substrate by using a conventional deposition technique, such as a physical vapor deposition (PVD), chemical vapor deposition (CVD), or electrolytic deposition, to form a layer stack. The layer stack is subsequently stripped from the substrate and ground to form a plurality of pigment flakes or preflakes. If preflakes are formed, the remaining component layers are then sequentially deposited on the preflakes to form a plurality of pigment flakes.

The plurality of pigment flakes may be combined with a binder medium to produce the coating composition of the present invention. Typically, the binder medium includes a resin that can be cured, for example, by evaporation, by heating, or by exposure to ultraviolet (UV) radiation. Suitable resins include alkyd resins, polyester resins, acrylic resins, polyurethane resins, vinyl resins, epoxy resins, styrene resins, and melamine resins. Optionally, the binder medium may include a solvent, such as an organic solvent or water, a cure retarder, such as clove oil, or other additives.

The coating composition may be used as a paint or an ink and applied to various objects, such as currency and security documents, product packagings, fabrics, motorized vehicles, sporting goods, electronic housings, household appliances, architectural structures, and floorings. Preferably, the coating composition is an interference coating composition providing a color-shifting effect through the interference of light.

Being relatively safe for human health and the environment, the coating composition is well-suited for use in applications where chemical safety is a concern and for use under conditions where chemical release is likely to occur.

Being magnetic, the coating composition is also well-suited for use in printing optical-effect images, such as three-dimensional, illusionary, and/or kinematic images, by aligning the magnetic pigment flakes within the coating composition with a magnetic field. A variety of optical-effect images for decorative and security applications can be produced by various methods, as disclosed in U.S. Pat. No. 6,759,097, in U.S. Pat. No. 7,047,883 to Raksha, et al., issued on May 23, 2006, in U.S. Patent Application Publication No. 2006/0081151 to Raksha, et al., published on Apr. 20, 2006, and in U.S. Patent Application Publication No. 2007/0268349 to Kurman, published on Nov. 22, 2007, for example, which are incorporated herein by reference.

Generally, the coating composition is printed on a substrate by a conventional printing technique, such as gravure, stamping, intaglio, flexographic, silk-screen, jet, or lithographic printing. While still fluid or after being re-fluidized, the coating composition is exposed to a magnetic field, which aligns the magnetic pigment flakes within the coating in a desired pattern. The binder medium within the coating composition is then cured, for example, by evaporation, by heating, or by exposure to UV radiation, fixing the alignment of the pigment flakes in the desired pattern to form the optical-effect image.

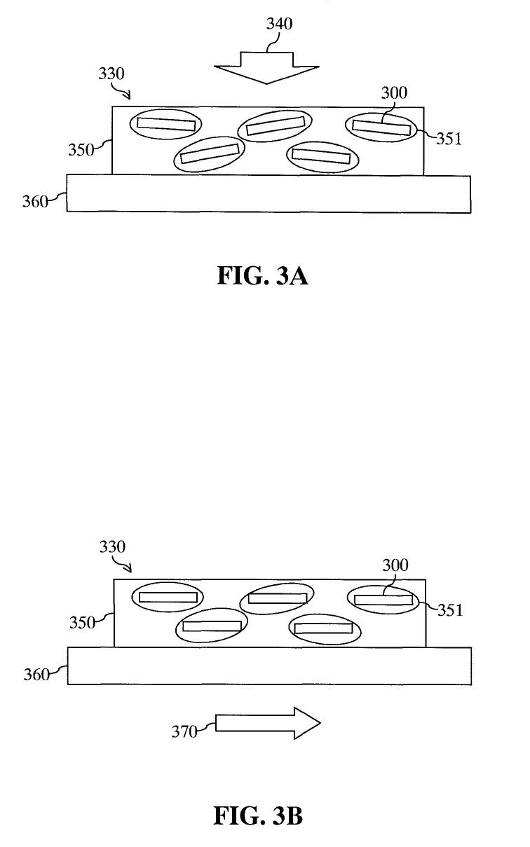

With reference to FIGS. 3A and 3B, a preferred embodiment of the coating composition 330, which is well-suited for use as an intaglio ink, includes pigment flakes 300 that absorb microwave radiation 340 disposed in a high-viscosity binder medium 350. The coating composition 330 is printed on a substrate 360. With particular reference to FIG. 3A, when the coating composition 330 is exposed to microwave radiation 340, the pigment flakes 300 absorb the microwave radiation 340, generating heat. The generated heat reduces the viscosity of the binder medium 350 in microcapsules 351 surrounding the pigment flakes 300. Advantageously, it is only necessary to apply enough microwave radiation 340 to the coating composition 330 to reduce the viscosity within the microcapsules 351, rather than within the binder medium 350 as a whole.

With particular reference to FIG. 3B, when the coating composition 330 is soon afterward exposed to a magnetic field 370, the pigment flakes 300, which are free to move within the low-viscosity microcapsules 351, align themselves with the magnetic field 370. The coating composition 330 is then removed from the magnetic field 370 and is cured by evaporation, fixing the alignment of the pigment flakes 300. Although the pigment flakes 300 are illustrated in FIG. 3B as being aligned parallel to the substrate 360, the pigment flakes 300 may be aligned in numerous other patterns by varying the direction and intensity of the magnetic field 370.

Of course, numerous other embodiments of the coating composition provided by the present invention may be envisaged without departing from the spirit and scope of the invention.

We claim:

1. A magnetic multilayer pigment flake comprising one or more magnetic layers of a magnetic alloy having a substantially nickel-free composition including about 40 wt % to about 90 wt % iron, about 10 wt % to about 50 wt % chromium, and about 0 wt % to about 30 wt % aluminum.

2. The pigment flake of claim 1, wherein the composition of the magnetic alloy is selected to minimize chromium(VI) release.

3. The pigment flake of claim 1, wherein the magnetic alloy is an iron-chromium alloy, and wherein the composition consists of about 10 wt % to about 50 wt % chromium, and a balance of iron.

4. The pigment flake of claim 1, wherein the magnetic alloy is an iron-chromium-aluminum alloy, and wherein the composition consists of about 20 wt % to about 30 wt % chromium, about 20 wt % to about 30 wt % aluminum, and a balance of iron.

5. The pigment flake of claim 1, further comprising a plurality of dielectric layers, wherein the one or more magnetic layers consist of a plurality of magnetic layers.

6. The pigment flake of claim 5, wherein the pigment flake has an interference layer structure, such that the pigment flake changes color with viewing angle or angle of incident light.

7. The multilayer pigment flake of claim 6, further comprising a central opaque reflecting layer of aluminum; wherein the plurality of magnetic layers include first and second semi-transparent absorbing magnetic layers; wherein the plurality of dielectric layers include first and second transparent dielectric layers; wherein the first transparent dielectric layer overlies the first semi-transparent magnetic layer; wherein the central opaque reflecting layer overlies the first transparent dielectric layer; wherein the second transparent dielectric layer overlies the central opaque reflecting layer; and wherein the second semi-transparent absorbing magnetic layer overlies the second transparent dielectric layer.

8. The pigment flake of claim 6, wherein the plurality of magnetic layers alternate with the plurality of dielectric layers, and wherein the pigment flake absorbs microwave radiation, such that the pigment flake can be heated with microwave radiation.

9. The multilayer pigment flake of claim 8, wherein the pigment flake has a layer-thickness profile selected to optimize resonant microwave absorption.

10. The multilayer pigment flake of claim 8, wherein the plurality of magnetic layers include first and second semi-transparent absorbing magnetic layers, and a central opaque reflecting magnetic layer; wherein the plurality of dielectric layers include first and second transparent dielectric layers; wherein the first transparent dielectric layer overlies the first semi-transparent magnetic layer; wherein the central opaque reflecting magnetic layer overlies the first transparent dielectric layer; wherein the second transparent dielectric layer overlies the central opaque reflecting magnetic layer; and wherein the second semi-transparent absorbing magnetic layer overlies the second transparent dielectric layer.

11. The multilayer pigment flake of claim 8, wherein the plurality of magnetic layers include first and second semi-transparent absorbing magnetic layers, and first, second, third, and fourth opaque reflecting magnetic layers; wherein the plurality of dielectric layers include first, second, third, fourth, and fifth transparent dielectric layers; wherein the first transparent dielectric layer overlies the first semi-transparent magnetic layer; wherein the first opaque reflecting magnetic layer overlies the first transparent dielectric layer; wherein the second transparent dielectric layer overlies the first opaque reflecting magnetic layer; wherein the second opaque reflecting magnetic layer overlies the second transparent dielectric layer; wherein the third transparent dielectric layer overlies the second opaque reflecting magnetic layer; wherein the third opaque reflecting magnetic layer overlies the third transparent dielectric layer; wherein the fourth transparent dielectric layer overlies the third opaque reflecting magnetic layer; wherein the fourth opaque reflecting magnetic layer overlies the fourth transparent dielectric layer; wherein the fifth transparent dielectric layer overlies the fourth opaque reflecting magnetic layer; and wherein the second semi-transparent absorbing magnetic layer overlies the fifth transparent dielectric layer.

12. A magnetic coating composition, comprising: a binder medium; and a plurality of magnetic multilayer pigment flakes disposed in the binder medium, wherein the plurality of pigment flakes each comprise one or more magnetic layers of a magnetic alloy having a substantially nickel-free composition including about 40 wt % to about 90 wt % iron, about 10 wt % to about 50 wt % chromium, and about 0 wt % to about 30 wt % aluminum.

13. The coating composition of claim 12, wherein the composition of the magnetic alloy is selected to minimize chromium(VI) release.

14. The coating composition of claim 12, wherein the magnetic alloy is an iron-chromium alloy or an iron-chromium-aluminum alloy.

15. The coating composition of claim 12, wherein the plurality of pigment flakes each further comprise a plurality of dielectric layers, and wherein the one or more magnetic layers consist of a plurality of magnetic layers.

16. The coating composition of claim 15, wherein the plurality of pigment flakes each have an interference layer structure, such that the plurality of pigment flakes change color with viewing angle or angle of incident light.

17. The coating composition of claim 16, wherein the plurality of magnetic layers alternate with the plurality of dielectric layers in each of the plurality of pigment flakes, and wherein the plurality of pigment flakes absorb microwave radiation, such that the plurality of pigment flakes can be heated with microwave radiation.

18. The coating composition of claim 17, wherein the binder medium is a high-viscosity binder medium, and wherein the coating composition is an intaglio ink.
